(19) United States
(12) Patent Application Publication
(10) Pub. No.: US 2025/0343257 A1
(43) Pub. Date: Nov. 6, 2025

(54) BATTERY WITH ELASTIC PORTION

(71) Applicant: GM Global Technology Operations LLC, Detroit, MI (US)

(72) Inventors: Insun Yoon, Shelby Township, MI (US); Kyungjae Lee, Rochester Hills, MI (US); Hanho Yun, Oakland Twp, MI (US); Anne M. Dailly, West Bloomfield, MI (US); Fang Dai, Troy, MI (US)

(21) Appl. No.: 18/651,939

(22) Filed: May 1, 2024

(51) Int. Cl. H01M 10/04; H01M 50/209; H01M 50/249

(52) U.S. Cl. CPC H01M 10/0468; H01M 50/249; H01M 50/209

(57) ABSTRACT

A battery assembly defines a first axis, a second axis orthogonal to the first axis, and a third axis orthogonal to the first axis and the second axis. The battery assembly includes a casing having a plurality of plates, and a plurality of battery cells stacked along the third axis disposed within the casing. At least one of the plates of the casing that extends along the third axis includes an elastic portion and provides a tension force on the plurality of battery cells to compress the plurality of battery cells together.

### INTRODUCTION

The subject disclosure relates to the art of rechargeable energy storage systems and, more particularly, to a battery with an elastic portion.

Rechargeable energy storage systems may include different types of rechargeable energy storage cells disposed in a casing with plates. In rechargeable energy storage systems, improvements in battery life are desirable.

### SUMMARY

In one exemplary embodiment, a battery assembly defines a first axis, a second axis orthogonal to the first axis, and a third axis orthogonal to the first axis and the second axis. The battery assembly comprises a casing comprising a plurality of plates, and a plurality of battery cells stacked along the third axis disposed within the casing. At least one of the plates of the casing that extends along the third axis comprises an elastic portion and provides a tension force on the plurality of battery cells to compress the plurality of battery cells together.

In addition to one or more of the features described herein, the elastic portion comprises at least one cutout portion.

In addition to one or more of the features described herein, the elastic portion comprises a spring structure.

In addition to one or more of the features described herein, the elastic portion comprises a mesh structure.

In addition to one or more of the features described herein, the elastic portion comprises a spiral structure.

In addition to one or more of the features described herein, wherein the plurality of plates comprises at least one side plate, and the elastic portion is formed on the at least one side plate.

In addition to one or more of the features described herein, the plurality of plates comprises a top plate or a bottom plate, and the elastic portion is formed on the top plate or the bottom plate.

In addition to one or more of the features described herein, the plurality of plates comprises a pair of end plates, and the at least one of the plates of the casing that extends along the third axis is coupled to the pair of end plates and transmits the tension force on the pair of end plates that transmit the tension force to the plurality of battery cells.

In addition to one or more of the features described herein, the battery cells are prismatic cells.

In addition to one or more of the features described herein, the elastic portion is structured such that the at least one of the plates of the casing that extends along the third axis has a spring constant that generates the tension force generating a stacking pressure of the plurality of battery cells in a range between 20 psi and 1500 psi.

In addition to one or more of the features described herein, the spring constant does not exceed 1000 psi.

In addition to one or more of the features described herein, the spring constant does not exceed 800 psi.

In addition to one or more of the features described herein, the at least one of the plates of the casing that extends along the third axis comprises a first clamp on a first end thereof along the third axis, and a second clamp on a second end thereof along the third axis.

In addition to one or more of the features described herein, the first clamp clamps onto a first end plate of the plurality of plates, and the second clamp clamps onto a second end plate of the plurality of plates.

In addition to one or more of the features described herein,

In yet another exemplary embodiment, a battery cell for a battery assembly defining a first axis, a second axis orthogonal to the first axis, and a third axis orthogonal to the first axis and the second axis. The battery cell comprises an electrode package having a plurality of electrode stacks stacked along the third axis, a can in which the electrode stacks are disposed, and a top cover disposed on the can. The top cover or at least one of walls of the can that extends along the third axis comprises an elastic portion.

In addition to one or more of the features described herein, the elastic portion comprises at least one cutout portion.

In addition to one or more of the features described herein, the elastic portion comprises a spring structure.

In addition to one or more of the features described herein, the elastic portion comprises a mesh structure.

In addition to one or more of the features described herein, the elastic portion comprises a spiral structure.

In yet another exemplary embodiment, a vehicle comprises a battery assembly defining a first axis, a second axis orthogonal to the first axis, and a third axis orthogonal to the first axis and the second axis. The battery assembly comprises a casing comprising a first side plate and a second side plate that extend along the third axis, and a plurality of battery cells stacked along the third axis from a first end to a second end disposed within the casing. The first side plate comprises a first elastic portion and the second side plate comprises a second elastic portion. The first side plate and the second side plate provide a tension force on the plurality of battery cells to compress the plurality of battery cells together. Each of the battery cells comprises an electrode package having a plurality of electrode stacks stacked along the third axis, and a can in which the plurality of battery cells are disposed. The can comprises a first side wall and a second side wall that extend along the third axis. The first side wall comprises a third elastic portion and the second side wall comprises a fourth elastic portion.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a left side view of a vehicle including a battery pack according to a non-limiting example;

FIG. 2 is a disassembled perspective view of a battery assembly according to one or more embodiments;

FIGS. 3A and 3B are schematic views of an elastic plate according to one or more embodiments;

FIGS. 4A and 4B are schematic views of an elastic plate according to one or more embodiments;

FIG. 5 is a schematic view of an elastic portion of an elastic plate according to one or more embodiments;

FIG. 6 is a disassembled perspective view of a battery cell according to one or more embodiments; and

FIG. 7 is a perspective view of a clamping structure according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

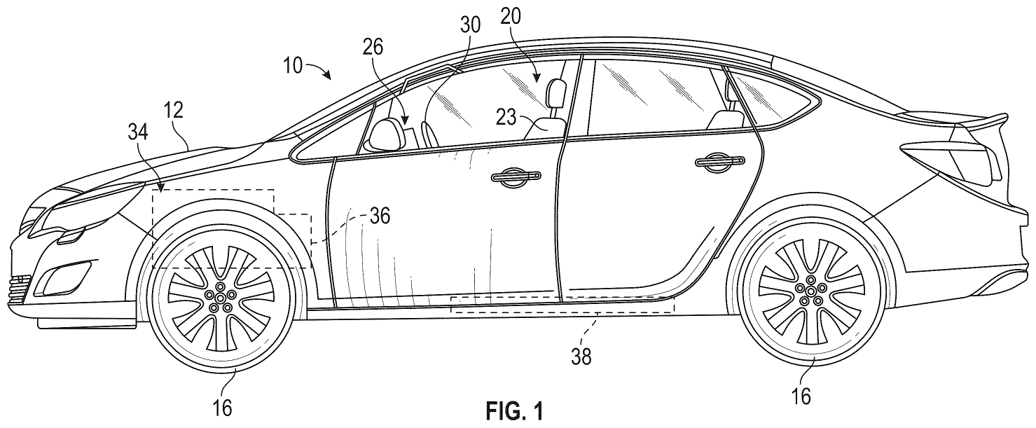

A vehicle 10 according to a non-limiting example is shown in FIG. 1. The vehicle 10 includes a body 12 supported on a plurality of wheels 16. One or more of the plurality of wheels 16 are steerable. The body 12 defines, in part, a passenger compartment 20 having seats 23 positioned behind a dashboard 26. A steering control 30 is arranged between seats 23 and a dashboard 26. The steering control 30 is operated to control orientation of the steerable wheel(s) 16.

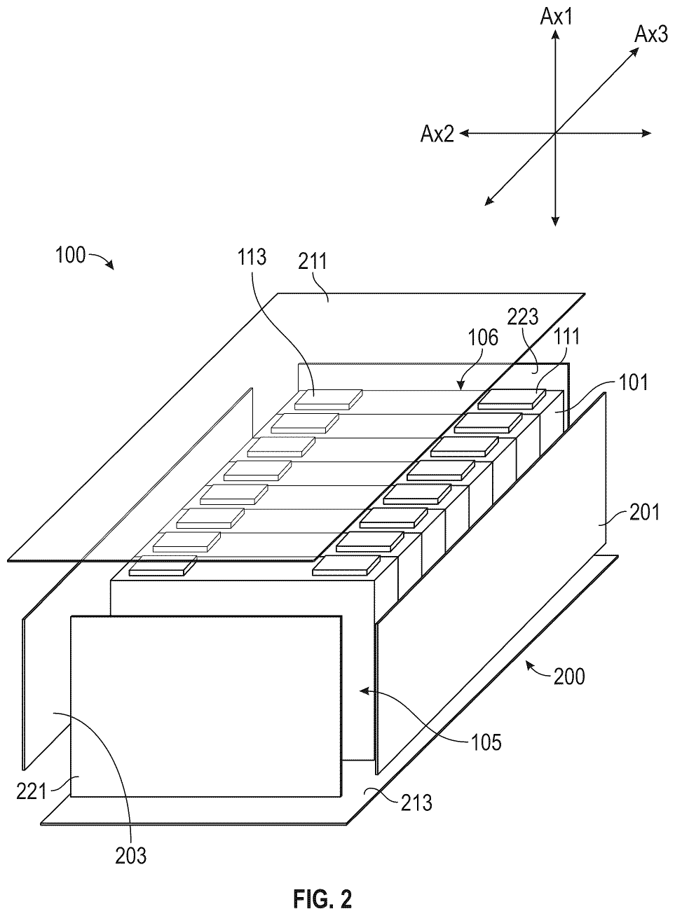

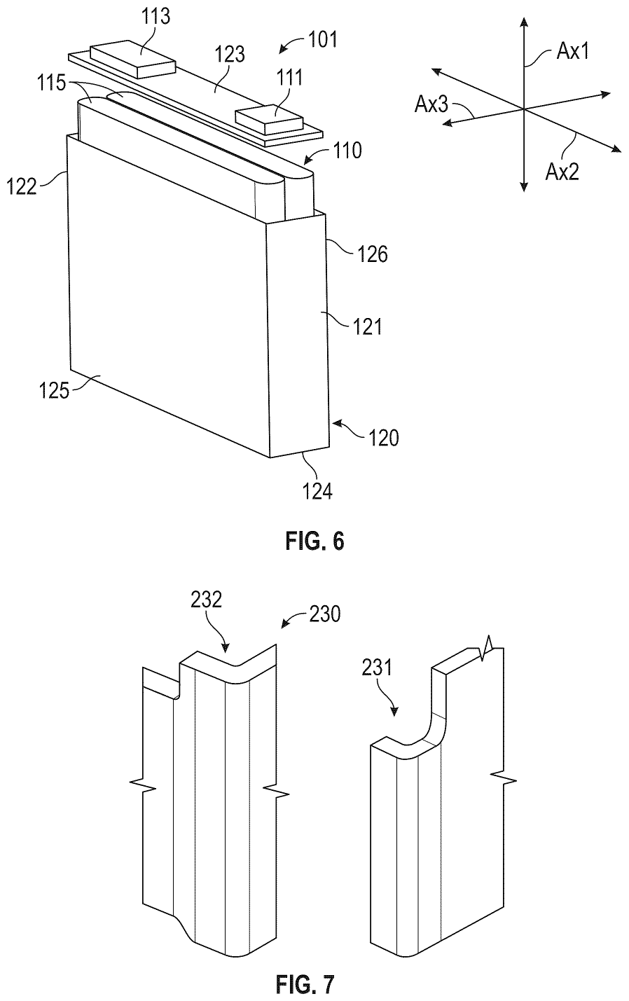

The vehicle 10 includes an electric motor 34 connected to a gear assembly and/or transmission 36 that provides power to one or more of the plurality of wheels 16. A rechargeable energy storage system 38 is arranged in the body 12 and provides power to the electric motor 34. While specific locations are shown for the electric motor 34, the gear assembly and/or transmission 36, and the rechargeable energy storage system 38 in FIG. 1, these locations are merely exemplary and not limiting, and locations of these structures may vary. According to one or more embodiments, the rechargeable energy storage system 38 includes a battery assembly 100 as shown in FIG. 2 and/or a battery cell 101 shown in FIG. 6.

FIG. 2 shows a battery assembly 100 according to one or more embodiments. The battery assembly 100 defines a first axis Ax1, a second axis Ax2 orthogonal to the first axis Ax1, and a third axis Ax3 orthogonal to the first axis Ax1 and the second axis Ax2. According to one or more embodiments, the first axis Ax1 may be a vertical axis, the second axis Ax2 may be a lateral axis, and the third axis Ax3 may be a longitudinal axis.

The battery assembly 100 includes a plurality of battery cells 101 that are stacked along the third axis Ax3. While FIG. 2 shows eight battery cells 101, the present disclosure is not limited thereto. The battery cells 101 may be prismatic cells. The battery cells 101 may include Li-ion, Li-metal, Li—S, and Na-ion, although the present disclosure is not limited thereto. Each of the battery cells 101 includes a first terminal 111 and a second terminal 113.

The stack of the battery cells 101 may be disposed within a casing 200. The casing 200 may include a first end plate 221 disposed on a first end 105 of the stack of the battery cells 101 along the third axis Ax3, and a second end plate 223 disposed on a second end 106 of the stack of the battery cells 101 along the third axis Ax3. The casing 200 may further include a first side plate 201 and a second side plate 203 on opposite ends of the battery cells 101 along the second axis Ax2. The first side plate 201 and the second side plate 203 may be attached to the first end plate 221 on one end along the third axis Ax3, and the first side plate 201 and the second side plate 203 may be attached to the second end plate 223 on the other end along the third axis Ax3. The casing 200 may further include a top plate 211 and a bottom plate 213 on opposite ends of the battery cells 101 along the first axis Ax1. The top plate 211 and the bottom plate 213 may be attached to the first end plate 221 on one end along the third axis Ax3, and the top plate 211 and the bottom plate 213 may be attached to the second end plate 223 on the other end along the third axis Ax3. Additionally or alternatively, the top plate 211 may be attached to the first side plate 201 and the second side plate 203 on one end along the first axis Ax1, and/or the bottom plate 213 may be attached to the first side plate 201 and the second side plate 203 on the other end along the first axis Ax1. The stack of the battery cells 101 may be compressed and bonded to the first side plate 201 and/or the second side plate 203. Additionally or alternatively, the stack of the battery cells 101 may be compressed and bonded to the top plate 211 and/or the bottom plate 213.

Although not shown, the battery assembly 100 may include additional structures. For example, an insulation pad may be disposed on both ends of the stack of the battery cells 101 along the second axis Ax2, and/or on both ends of the stack of the battery cells 101 along the third axis Ax3. According to one or more embodiments, a unitary insulation pad may wrap around the stack of the battery cells 101 to cover both ends of the stack of the battery cells 101 along the second axis Ax2, and both ends of the stack of the battery cells 101 along the third axis Ax3. The battery assembly 100 may include one or more busbar(s) electrically connecting the first terminals 111 and/or second terminals 113 of the battery cells 101, and one or more output busbars electrically connected to the busbar(s). An insulating cover may be disposed between the first end 105 of the stack of the battery cells 101 and the first end plate 221 and/or between the second end 106 of the stack of the battery cells 101 and the second end plate 223, and an output protection cover for covering the output busbar may be disposed on the insulating cover. The output protection cover may attach to a fastening structure on the first end plate 221 and/or the second end plate 223. A wiring harness board may be disposed on the stack of the battery cells 101.

During use of a battery assembly, active material volume change during the charging/or and discharging process may result in expansion of the materials within the battery cells. This expansion may be anisotropic, with the volume expansion occurring predominantly along the electrode/cell stacking direction. When the side, top, and bottom plates are non-elastic as is the case in conventional battery assemblies, the battery cells are prevented from expanding by the side, top, and/or bottom plates restraining the stack of the battery cells along the stacking direction of the battery cells. Thus, as the materials within the battery cells expand, the density thereof increases, increasing the pressure within the battery cells. While an elevated pressure within the battery cells may improve life of the battery assembly up to a certain threshold, it was discovered that the life of the battery assembly may be negatively impacted if the pressure within the battery cells exceeds the threshold. With the conventional battery assembly, internal pressures within the battery cells are not controlled during use such that the internal pressures may exceed the threshold, thereby shortening the life of the battery assembly. It is noted that the threshold may depend on the materials within the battery cells, the structure of the battery cells, as well as structures that interface with the battery cells that may be negatively affected when a pressure acting thereon becomes excessive.

It was unexpectedly discovered that, by allowing for a controlled expansion of the battery cells 101 of the battery assembly 100, the pressures within the battery cells 101 may be maintained within a desired range during use, lengthening the life of the battery assembly 100. It was also discovered that such controlled expansion may be accomplished by using elastic plates and/or elastic portions in the first side plate 201, the second side plate 203, the top plate 211, and/or the bottom plate 213 of the casing 200 of the battery assembly 100 that extend in the stacking direction of the battery cells 101 (i.e., along the third axis Ax3). The elastic plate(s) may allow a degree of internal cell expansion within the battery cells 101 and, by specifically structuring the elastic plates, the expansion may be controlled to regulate the internal pressure within the battery cells 101.

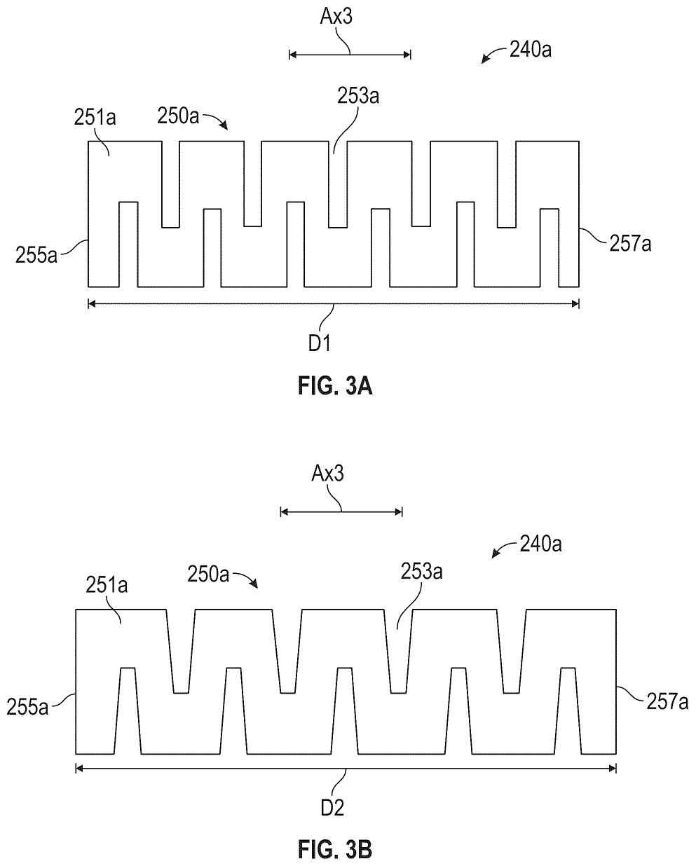

FIGS. 3A and 3B show an elastic plate 240a according to one or more embodiments. According to one or more embodiments, the elastic plate 240a may be employed for the first side plate 201, the second side plate 203, the top plate 211, and/or the bottom plate 213. According to one or more embodiments, the elastic plate 240a may form only a portion of the first side plate 201, the second side plate 203, the top plate 211, and/or the bottom plate 213.

The elastic plate 240a includes an elastic portion 250a. While FIGS. 3A and 3B show the elastic portion 250a forming an entirety of the elastic plate 240a, the present disclosure is not limited thereto, and the elastic portion 250a may form only a part of the elastic plate 240a. In the embodiment shown in FIGS. 3A and 3B, the elastic portion 250a is structured as a spring, with a main body portion 251a separated by a plurality of cutout portions 253a. The cutout portions 253a may be cut out of the main body portion 251a or, alternatively, the main body portion 251a may be formed with the cutout portions 253a. The cutout portions 253a may be shaped as notches. The elastic plate 240a includes a first end 255a and a second end 257a opposite each other along the third axis Ax3.

FIG. 3A shows an initial configuration of the elastic plate 240a in which the elastic plate 240a is employed for the first side plate 201, the second side plate 203, the top plate 211, and/or the bottom plate 213 of the battery assembly 100 at or near atmospheric temperature. In the initial configuration, a distance between the first end 255a and the second end 257a of the elastic portion 250a is a first distance D1.

The elastic plate 240a shown in FIG. 3A may expand during use. For example, when the elastic plate 240a is employed for the first side plate 201, the second side plate 203, the top plate 211, and/or the bottom plate 213 of the battery assembly 100, as the volume of the active materials within the battery cells 101 increases during charge and/or discharge, the elastic portion 250a expands along the third axis Ax3 allowing the battery cells 101 to expand. Thus, the internal pressure within the battery cells 101 may be less than for a non-elastic plate.

FIG. 3B shows an expanded configuration of the elastic plate 240a in which the elastic plate 240a is employed for the first side plate 201, the second side plate 203, the top plate 211, and/or the bottom plate 213 of the battery assembly 100 when active material volume increases during charge and/or discharge. In the expanded configuration, the distance between the first end 255a and the second end 257a of the elastic portion 250a is a second distance D2 greater than the first distance D1. As shown in FIGS. 3A and 3B, as the elastic portion 250a expands along the third axis Ax3, the cutout portions 253a increase in size along the third axis Ax3.

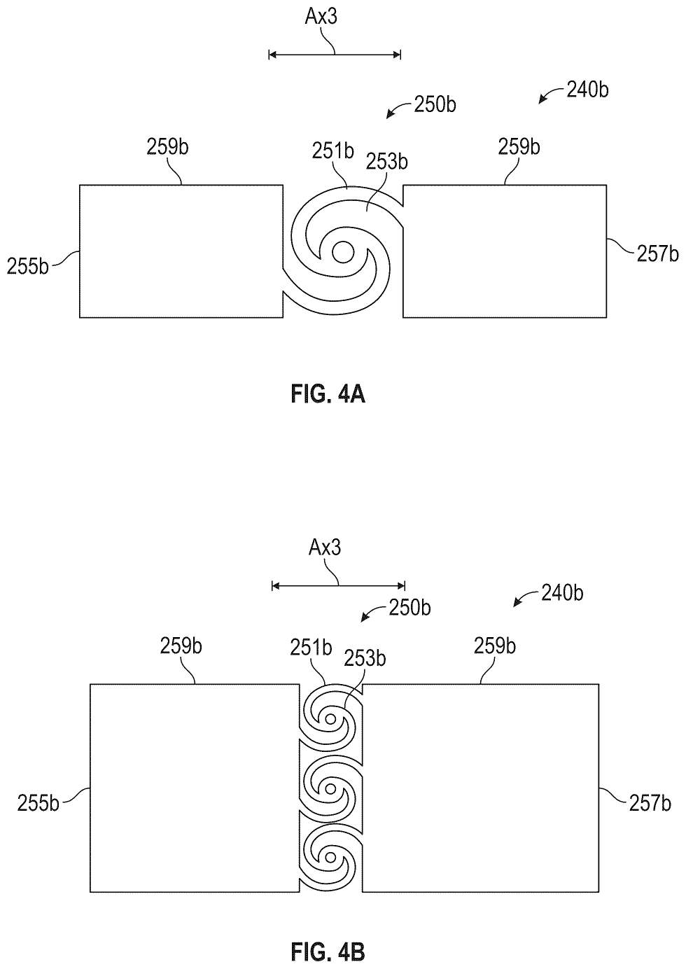

FIGS. 4A and 4B show an elastic plate 240b according to one or more embodiments. According to one or more embodiments, the elastic plate 240b may be employed for the first side plate 201, the second side plate 203, the top plate 211, and/or the bottom plate 213. According to one or more embodiments, the elastic plate 240b may form only a portion of the first side plate 201, the second side plate 203, the top plate 211, and/or the bottom plate 213.

The elastic plate 240b may include an elastic portion 250b between non-elastic portions 259b. In the embodiment shown in FIG. 4A, the elastic portion 250b is structured as single spiral structure, with a main body portion 251b in a spiral shape extending between the non-elastic portions 259b and having a plurality of cutout portions 253b. In the embodiment shown in FIG. 4B, the elastic portion 250b is structured as a plurality of spiral structures, with each of the spiral structures having a main body portion 251b in a spiral shape extending between the non-elastic portions 259b and having a plurality of cutout portions 253b. While FIG. 4B shows the elastic portion 250b having three spiral structures, the present disclosure is not limited thereto. While FIG. 4B shows the elastic portion 250b having a single row of spiral structures, the present disclosure is not limited thereto. The cutout portions 253b may be cut out of the main body portion 251b or, alternatively, the main body portion 251b may be formed with the cutout portions 253b. The elastic plate 240b includes a first end 255b and a second end 257b opposite each other along the third axis Ax3.

Similarly to the elastic plate 240a shown in FIGS. 3A and 3B, the elastic plate 240b shown in FIGS. 4A and 4B may expand during use. For example, when the elastic plate 240b is employed for the first side plate 201, the second side plate 203, the top plate 211, and/or the bottom plate 213 of the battery assembly 100, as the active material within the battery cells 101 increases in volume during charge and/or discharge, the elastic portion 250b expands along the third axis Ax3 allowing the battery cells 101 to expand. Thus, the internal pressure within the battery cells 101 may be less than for a non-elastic plate.

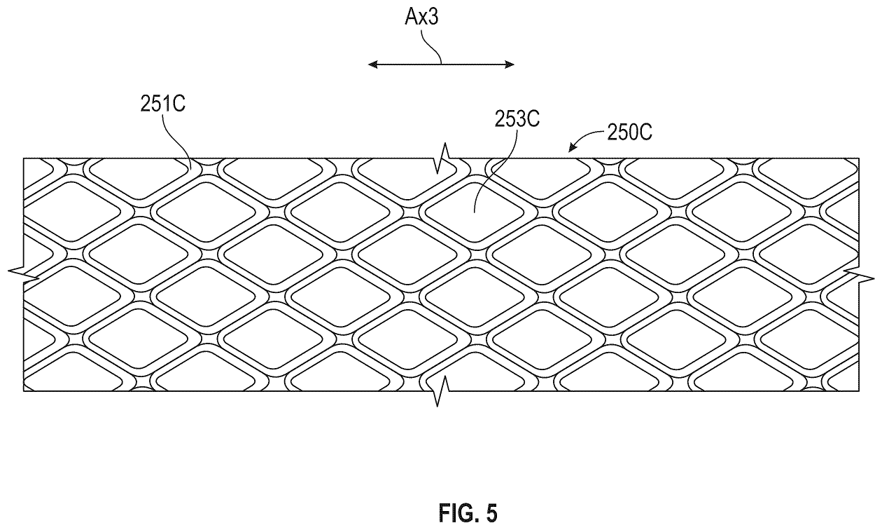

FIG. 5 shows an elastic portion 250c according to one or more embodiments. The elastic portion 250c shown in FIG. 5 has a mesh pattern with a main body portion 251c and a plurality of cutout portions 253c formed therein. The cutout portions 253c may be cut out of the main body portion 251c or, alternatively, the main body portion 251c may be formed with the cutout portions 253c. According to one or more embodiments, the elastic portion 250c may be employed within the first side plate 201, the second side plate 203, the top plate 211, and/or the bottom plate 213. According to one or more embodiments, an entirety of the first side plate 201, the second side plate 203, the top plate 211, and/or the bottom plate 213 may include the elastic portion 250c. According to one or more embodiments, the elastic portion 240c may extend between non-elastic portions along the third axis Ax3. While a specific mesh pattern is shown for the elastic portion 250c, the present disclosure is not limited thereto.

Similarly to the elastic portion 250a shown in FIGS. 3A and 3B and the elastic portion 250b shown in FIGS. 4A and 4B, the elastic portion 250c shown in FIG. 5 may expand during use. For example, when the elastic portion 250c is employed within the first side plate 201, the second side plate 203, the top plate 211, and/or the bottom plate 213 of the battery assembly 100, as the volume of the active material in the battery cells 101 increases during charge and/or discharge, the elastic portion 250c expands along the third axis Ax3 allowing the battery cells 101 to expand. Thus, the internal pressure within the battery cells 101 may be less than for a non-elastic plate.

According to one or more embodiments, the first side plate 201, the second side plate 203, the top plate 211, and/or the bottom plate 213 may be formed with one or more of the elastic portions 250a, 250b, 250c that are structured to have a modulus of elasticity and/or a spring constant such that, during use of the battery assembly 100, the internal pressure within the battery cells 101 of the battery assembly 100 does not exceed a predetermined threshold. That is, by including one or more of the elastic portions 250a, 250b, 250c, the modulus of elasticity and/or the spring constant of the first side plate 201, the second side plate 203, the top plate 211, and/or the bottom plate 213 may be selected to control the internal pressure range within the battery cells 101 during use such that the predetermined threshold is not exceeded. A stacking pressure of the battery cells 101 due to tension forces of the casing 200 may correlate to the internal pressure within the battery cells 101. Thus, by controlling the stacking pressure, the internal pressure within the battery cells 101 may be controlled. Furthermore, excessive stacking pressure may negatively affect structural components of the battery assembly 100 outside of the battery cells 101 as well. According to one or more embodiments, a stacking pressure of the battery cells 101 may be maintained within a range of 20 psi to 1500 psi. According to one or more embodiments, a stacking pressure of the battery cells 101 may be maintained within a range of 20 psi to 800 psi. According to one or more embodiments, a stacking pressure of the battery cells 101 may be maintained within a range of 200 psi to 1500 psi. According to one or more embodiments, a stacking pressure of the battery cells 101 may be maintained within a range of 200 psi to 800 psi.

The modulus of elasticity and/or the spring constant of the elastic portions 250a, 250b, 250c may be tuned by adjusting the number, size, and shapes of the cutout portions 253a, 253b, 253c. The cutout portions 253a, 253b, 253c may provide an additional benefit of reducing the mass of the first side plate 201, the second side plate 203, the top plate 211, and/or the bottom plate 213, thereby reducing the weight of the battery assembly 100. Reduction in weight of the battery assembly 100 reduces the weight of the vehicle 10, which may result in improved vehicle performance.

While specific examples of the elastic portions 250a, 250b, 250c are set forth above, the present disclosure is not limited thereto. Other planar elastic structures known in the art may be employed.

FIG. 6 shows a battery cell 101 according to one or more embodiments. The battery cell 101 may be a prismatic cell. The battery cell 101 may be disposed within the casing 200 as shown in FIG. 2 to form a battery assembly 100 that defines a first axis Ax1, a second axis Ax2 orthogonal to the first axis Ax1, and a third axis Ax3 orthogonal to the first axis Ax1 and the second axis Ax2.

The battery cell 101 includes an electrode package 110 in which electrode stacks 115 are stacked along the third axis Ax3. While FIG. 6 shows two electrode stacks 115, the electrode package 110 may include any number of electrode stacks 115 stacked along the third axis Ax3. Each of the electrode stacks 115 may include a plurality of electrodes stacked along the third axis Ax3. The electrode package 110 may include Li-ion, Li-metal, Li—S, and Na-ion, although the present disclosure is not limited thereto.

The electrode package 110 may be disposed within a can 120. The can 120 may include a first end wall 125 and a second end wall 126 disposed on opposite ends of the electrode package 110 along the third axis Ax3. The can 120 may further include a first side wall 121 and a second side wall 122 on opposite ends of the electrode package 110 along the second axis Ax2. The first side wall 121 and the second side wall 122 may be attached to the first end wall 125 on one end along the third axis Ax3, and the first side wall 121 and the second side wall 122 may be attached to the second end wall 126 on the other end along the third axis Ax3. The can 120 may further include a bottom wall 124 on one end of the electrode package 110 along the first axis Ax1. A top cover 123 may be disposed on the other end of the electrode package 110 along the first axis Ax1, atop the can 120. The top cover 123 and the bottom wall 124 may be attached to the first end wall 125 on one end along the third axis Ax3, and the top cover 123 and the bottom wall 124 may be attached to the second end wall 126 on the other end along the third axis Ax3. Additionally, the top cover 123 may be attached to the first side wall 121 and the second side wall 122 on one end along the first axis Ax1, and the bottom wall 124 may be attached to the first side plate 201 and the second side plate 203 on the other end along the first axis Ax1. A first terminal 111 and a second terminal 113 may be formed on the top cover 123.

The first side wall 121 and/or the second side wall 122 may include an elastic portion 250a, 250b, 250c according to one or more embodiments. Additionally or alternatively, the top cover 123 and/or the bottom wall 124 may include an elastic portion 250a, 250b, 250c according to one or more embodiments. While the elastic portion(s) 250a, 250b, 250c within the first side wall 121, the second side wall 122, the top cover 123, and/or the bottom wall 124 may function similarly as for the casing 200 of the battery assembly 100 described above, by applying the elastic portion(s) 250a, 250b, 250c at the battery cell 101 level, the internal pressure within the battery cell 101 may be more precisely controlled.

Although not shown, additional structures may be added to the battery cell 101. According to one or more embodiments, clamp inserts may be added for clamping the electrode package 120 to the first side wall 121, the second side wall 122, the top cover 123, and/or the bottom wall 124. According to one or more embodiments, in view of the cutout portions 253a, 253b, 253c, sealing elements may be added to seal the electrode package 120.

According to one or more embodiments, the elastic portion(s) 250a, 250b, 250c within the first side wall 121, the second side wall 122, the top cover 123, and/or the bottom wall 124 shown in FIG. 2 may be employed concurrently with the elastic portion(s) 250a, 250b, 250c within the first side plate 201, the second side plate 203, the top plate 211, and/or the bottom plate 213.

FIG. 7 shows a clamping structure 230 according to one or more embodiments. The clamping structure 230 may include a clamp 231 and a clamp receiving portion 232. The clamp 231 may be disposed on the first side plate 201, the second side plate 203, the top plate 211, and/or the bottom plate 213, and the clamp receiving portion 232 may be disposed on the first end plate 221 and/or the second end plate 223. Thus, a clamping engagement may be achieved between the first side plate 201, the second side plate 203, the top plate 211, and/or the bottom plate 213, and the first end plate 221 and/or the second end plate 223.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery assembly defining a first axis, a second axis orthogonal to the first axis, and a third axis orthogonal to the first axis and the second axis, the battery assembly comprising:
a casing comprising a plurality of plates; and
a plurality of battery cells stacked along the third axis disposed within the casing,
wherein at least one of the plates of the casing that extends along the third axis comprises an elastic portion and provides a tension force on the plurality of battery cells to compress the plurality of battery cells together.

2. The battery assembly of claim 1, wherein the elastic portion comprises at least one cutout portion.

3. The battery assembly of claim 1, wherein the elastic portion comprises a spring structure.

4. The battery assembly of claim 1, wherein the elastic portion comprises a mesh structure.

5. The battery assembly of claim 1, wherein the elastic portion comprises a spiral structure.

6. The battery assembly of claim 1,
wherein the plurality of plates comprises at least one side plate, and
wherein the elastic portion is formed on the at least one side plate.

7. The battery assembly of claim 1,
wherein the plurality of plates comprises a top plate or a bottom plate, and
wherein the elastic portion is formed on the top plate or the bottom plate.

8. The battery assembly of claim 1,
wherein the plurality of plates comprises a pair of end plates, and
wherein the at least one of the plates of the casing that extends along the third axis is coupled to the pair of end plates and transmits the tension force on the pair of end plates that transmit the tension force to the plurality of battery cells.

9. The battery assembly of claim 1, wherein the battery cells are prismatic cells.

10. The battery assembly of claim 1, wherein the elastic portion is structured such that the at least one of the plates of the casing that extends along the third axis has a spring constant that generates the tension force generating a stacking pressure of the plurality of battery cells in a range between 20 psi and 1500 psi.

11. The battery assembly of claim 10, wherein the spring constant does not exceed 1000 psi.

12. The battery assembly of claim 10, wherein the spring constant does not exceed 800 psi.

13. The battery assembly of claim 1, wherein the at least one of the plates of the casing that extends along the third axis comprises a first clamp on a first end thereof along the third axis, and a second clamp on a second end thereof along the third axis.

14. The battery assembly of claim 13, wherein the first clamp clamps onto a first end plate of the plurality of plates, and the second clamp clamps onto a second end plate of the plurality of plates.

15. A battery cell for a battery assembly defining a first axis, a second axis orthogonal to the first axis, and a third axis orthogonal to the first axis and the second axis, the battery cell comprising:
an electrode package having a plurality of electrode stacks stacked along the third axis;
a can in which the electrode stacks are disposed; and
a top cover disposed on the can,
wherein the top cover or at least one of walls of the can that extends along the third axis comprises an elastic portion.

16. The battery cell of claim 15, wherein the elastic portion comprises at least one cutout portion.

17. The battery cell of claim 15, wherein the elastic portion comprises a spring structure.

18. The battery cell of claim 15, wherein the elastic portion comprises a mesh structure.

19. The battery cell of claim 15, wherein the elastic portion comprises a spiral structure.

20. A vehicle, comprising:
a battery assembly defining a first axis, a second axis orthogonal to the first axis, and a third axis orthogonal to the first axis and the second axis, the battery assembly comprising:
a casing comprising a first side plate and a second side plate that extend along the third axis, and
a plurality of battery cells stacked along the third axis disposed within the casing,
wherein the first side plate comprises a first elastic portion and the second side plate comprises a second elastic portion,
wherein the first side plate and the second side plate provide a tension force on the plurality of battery cells to compress the plurality of battery cells together,
wherein each of the battery cells comprises:
an electrode package having a plurality of electrode stacks stacked along the third axis, and
a can in which the plurality of battery cells are disposed,
wherein the can comprises a first side wall and a second side wall that extend along the third axis, and
wherein the first side wall comprises a third elastic portion and the second side wall comprises a fourth elastic portion.
